(19) United States
(12) Patent Application Publication
(10) Pub. No.: US 2007/0204516 A1
(43) Pub. Date: Sep. 6, 2007

(54) Electronic window

(76) Inventor: Darl Jason McDorman, Defuniak Springs, FL (US)

Correspondence Address: Darl Jason McDorman, 444 Indian Creek Ranch West, Defuniak Springs, FL, 32435, US

(21) Appl. No.: 11/325,687

(22) Filed: Mar. 3, 2006

(51) Int. Cl. E05F 15/02

(52) U.S. Cl. 49/340

(57) ABSTRACT

The Electric window takes the makings of a standard window and makes an electric window by using a standard window and modifying it with exterior metal casing adding an electric motor, gears and a ball screw with ball nut and ball screw support.

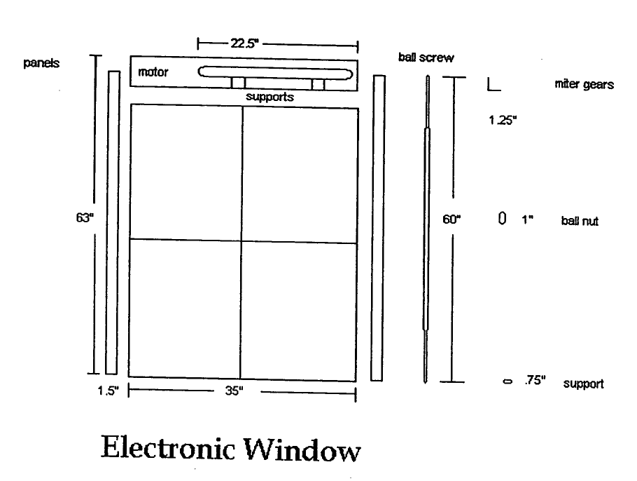

Pre built window with casing already installed around the manufacturers window extends one and one half inches on the sides in width sixty three inches on the sides in height past the manufacturers specification of a standard window extending thirty five inches in width on top and four inches in height on top past the manufacturers specification of a standard window. Installed on the top of the window in the rectangular space is the motor supported by 2 brackets which are fastened 2 the top of the window the motor is twenty 2 and a half inches in length 2 inches in diameter. An original window structure will make a place for the ball screw which is on the right of the window the ball screw is sixty inches in length and in metrics paint three inches in diameter.

Installed is 2 miter gears they go between the motor and the ball screw at a ninety degree angle the miter gears are one and a half inches in diameter and one inch in depth. Installed a long with the ball screw is a ball nut the ball nut will travel from bottom 2 top of the ball screw the ball nut is one inch in length and one half inch in diameter. There are 2 supports one which is located at the middle of the window fastened on 2 the lower part of the window that fastens 2 the ball nut the second is under the ball screw fastened 2 the bottom of the window.

What I claim for my invention is:

1. an electric window.
